(19) United States
(12) Patent Application Publication
(10) Pub. No.: US 2013/0187500 A1
(43) Pub. Date: Jul. 25, 2013

(54) DIRECT MACHINE MOUNTING FOR INSULATED STATOR OF OUTER ROTOR MOTOR

(71) Applicants: Daniel E. Bailey, Ballwin, MO (US); Philip S. Johnson, Granite City, IL (US); Daniel E. Hilton, St. Louis, MO (US)

(72) Inventors: Daniel E. Bailey, Ballwin, MO (US); Philip S. Johnson, Granite City, IL (US); Daniel E. Hilton, St. Louis, MO (US)

(73) Assignee: NIDEC MOTOR CORPORATION, St. Louis, MO (US)

(21) Appl. No.: 13/358,319

(22) Filed: Jan. 25, 2012

(51) Int. Cl. H02K 5/00

(52) U.S. Cl. 310/91

(57) ABSTRACT

Mounting structure is provided for support of a motor within a machine. More particularly, the mounting structure is configured for the support of a stator within the machine, with the mounting structure preventing axial and rotational movement of the stator relative thereto.

### BACKGROUND OF THE INVENTION

1. Field of the Invention

The present invention relates generally to a machine in which an electric motor is used. More specifically, the present invention concerns a machine having means by which an electric motor including a rotor and an insulated stator can be mounted directly to the machine.

2. Discussion of the Prior Art

Those of ordinary skill in the art will appreciate that electric motors are often used in home appliances such as dishwashers and washing machines. In a washing machine, for instance, an electric motor may be used to cause rotation of the washer basket to agitate the clothing contained therein. Although a variety of motor component arrangements may be used, one known embodiment of an electric motor includes a stator positioned at least in part radially inside a rotor. An electric motor having such a configuration is commonly referred to as an outer rotor motor or external rotor motor, although other names may be used. In the case of a washing machine having an electric motor of this sort, the rotor is typically coupled to the washer basket, whereas the stator is fixed to a tub mounting hub that is coupled to a stationary washer outer tub. To avoid potential electrical shock of the user, the stator is mounted in such a manner that it is electrically isolated from the tub.

The stator of an outer rotor motor typically includes a core and a plurality of coils. Conventionally, the core takes a generally toroidal form and is composed of a ferromagnetic metal such as iron or steel. The core typically includes a plurality of teeth projecting radially outwardly and defining slots therebetween. The coils are formed by the winding of electrically conductive wire multiple times around each tooth to at least partially fill the slots. Copper wire is commonly used due to its low electrical resistivity.

The rotor of an outer rotor motor typically includes a shaft, a support structure coupled to the shaft, and a plurality of permanent magnets supported by the support structure so that they circumscribe the stator in a spaced relationship. When an electrical current flows through the coils formed around each tooth of the stator core, the ferromagnetic material of the core is energized to form a plurality of magnetic fields corresponding to the teeth. These stator magnetic fields interact with the magnetic fields produced by the permanent magnets of the rotor to induce relative rotation between the rotor and stator. The direction of each magnetic field is dependent on the direction of the current flow around the respective tooth. Although a variety of approaches may be used to ensure appropriate field directions, one embodiment of an electric motor includes a stator having coils wound clockwise around some teeth and coils wound counter-clockwise around other teeth to produce oppositely directed magnetic fields within the same stator when the wires are exposed to a direct current.

Mounting of the outer rotor motor in the machine is conventionally done through alignment of openings in the stator core with corresponding openings in the tub mounting hub, followed by insertion of a fastener through each pair of openings. Such an approach is often inconvenient and expensive. For instance, traditional outer rotor motors are limited to a specific mounting arrangement incorporated into the core fabrication process. To use a conventional core in a different application requiring a different mounting arrangement, the core fabrication process must be varied (e.g., the lamination die for a laminated stator core must be re-machined). Furthermore, the metal core must be large enough to house the mounting openings, making it heavy and expensive. Even further, the increased number of components in the machine-motor system, including fasteners such as bolts or screws, slows the assembly process and increases the risk that a component necessary for assembly will be misplaced.

### SUMMARY

According to one aspect of the present invention, a machine is provided that includes a motor and motor mounting structure configured to support the motor within the machine. The motor includes a rotor rotatable about an axis and a stator spaced from the rotor. The stator presents axially spaced radial surfaces. The stator further presents radially spaced inner and outer circumferential faces. The motor mounting structure includes a mounting surface, a radially projecting shoulder, and a shiftable catch. The mounting surface engages at least one of the faces of the stator so as to restrict relative radial movement between the stator and mounting structure. The radially projecting shoulder engages one of the radial surfaces so as to prevent axial movement of the stator in a first axial direction. The shiftable catch removably engages the other one of the radial surfaces so as to prevent axial movement of the stator in a second axial direction opposite the first direction, when the catch is in a retaining position. The catch is moveable out of the retaining position to permit axial movement of the stator relative to the mounting structure.

According to another aspect of the present invention, a machine is provided that is configured to generally support a motor having a rotor rotatable about an axis and a stator spaced from the rotor, wherein the stator presents axially spaced radial surfaces and radially spaced inner and outer circumferential faces. The machine includes motor mounting structure configured to support the motor within the machine. The motor mounting structure includes a mounting surface, a radially projecting shoulder, and a shiftable catch. The mounting surface is configured to engage at least one of the faces of the stator, such that the mounting surface is operable to restrict relative radial movement between the stator and mounting structure. The radially projecting shoulder is configured to engage one of the radial surfaces, such that the shoulder is operable to prevent axial movement of the stator in a first axial direction. The shiftable catch is configured to removably engage the other one of the radial surfaces, such that the catch is operable to prevent axial movement of the stator in a second axial direction opposite the first direction, when the catch is in a retaining position. The catch is moveable out of the retaining position to permit axial movement of the stator relative to the mounting structure.

Among other things, provision of motor mounting structure independent of the stator core allows the size of the stator core to be reduced and increases the ease with which the motor can be adapted for use with new mounting systems.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a partial sectional bottom isometric view of a portion of a machine constructed in accordance with the principles of a preferred embodiment of the present invention, depicting a portion of a washing machine and an outer rotor electric motor;

FIG. 2 is an exploded isometric view of the stator and a portion of the tub of FIG. 1, particularly depicting the interengaging structures of the mounting structure and stator core and the radial thickness of the stator core;

FIG. 3 is an enlarged isometric view of the stator of FIGS. 1 and 2;

FIG. 4 is a sectional isometric view of a portion of the stator and tub of FIGS. 1-3, particularly depicting the engagement of the tub and mounting structure with the stator core; and

FIG. 5 is bottom view of the tub and stator of FIGS. 1-4.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

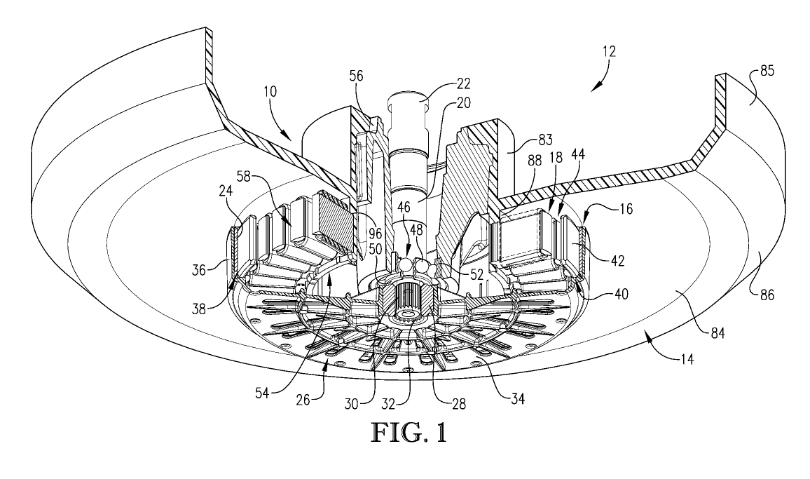

With initial reference to FIG. 1, an electric motor 10 constructed in accordance with a preferred embodiment of the present invention is depicted for use in a machine 12. The particular machine depicted in FIG. 1 is a washing mashing having a stationary tub 14 and a rotatable washer or agitator basket (not shown). However, a variety of machines, including but not limited to washing machines, fans, generators, and exercise equipment such as bicycles, are suitable for use with the present invention.

Referring again to FIG. 1, the motor 10 broadly includes a rotor 16 and a stator 18 spaced partially inside the rotor 16, as is customary. The rotor 16 includes a rotatable shaft 20 connectable to the rotatable basket of the machine 12 at a machine connection end 22. The rotor 16 also includes a backing ring 24 located radially outwardly from the shaft 20 to circumscribe the stator 18 in a spaced relationship. Preferably, the backing ring 24 comprises a sheet of metal wrapped five times around the outer circumference of the stator 18 so that the backing ring 24 includes five layers. (For the sake of clarity, individual layers of the backing ring 24 are not shown in FIG. 1.) Preferably, the metal comprises iron. However, a ring comprising a different number of layers or a single layer and/or comprising one of more of a variety of materials falls within the scope of the present invention.

In the preferred embodiment illustrated in FIG. 1, the backing ring 24 is positioned within an interconnecting element 26 that connects the backing ring 24 to a central coupler 28. The central coupler 28 is fixed to the shaft 20 so that the shaft 20, coupler 28, element 26, and backing ring 24 all rotate together. In the illustrated embodiment, the shaft 20 has a splined end 30 that meshes with the splines 32 on the coupler 28, although other suitable means may be incorporated to rotationally fix the components to one another. Preferably, the interconnecting element 26 includes a spoked base 34 projecting radially from the coupler 28. The element 26 further includes a circumferentially extending support wall 36 that projects axially from the base 34 and cooperates therewith to define a circumferentially extending channel 38 that houses the backing ring 24. In the preferred embodiment, the interconnecting element also defines a plurality of circumferentially spaced slots 40 positioned radially inwardly of the channel 38. The slots 40 house a plurality of permanent magnets 42 shaped such that a circumferential space 44 between the magnets 42 and the stator 18 is retained. However, a variety of means by which the backing ring 24 and the magnets 42 are appropriately positioned fall within the ambit of the present invention. It is also noted that the interconnecting element 26 is preferably a plastic component overmolded to the element 26 and the coupler 28. Although the preferred embodiment is an outer rotor motor, the principles of the present invention are equally applicable to other motor designs, including, for instance, those having an inner rotor encompassed by an outer stator.

Preferably, the rotor 16 is rotationally supported on the tub 14 by a bearing assembly 46. In the preferred embodiment shown in FIG. 1, the bearing assembly 46 includes a plurality of ball bearings 48 disposed between an inner race 50 and an outer race 52, although a different bearing type or an entirely different rotation isolation mechanism could be used to similar effect without departing from the spirit of the present invention.

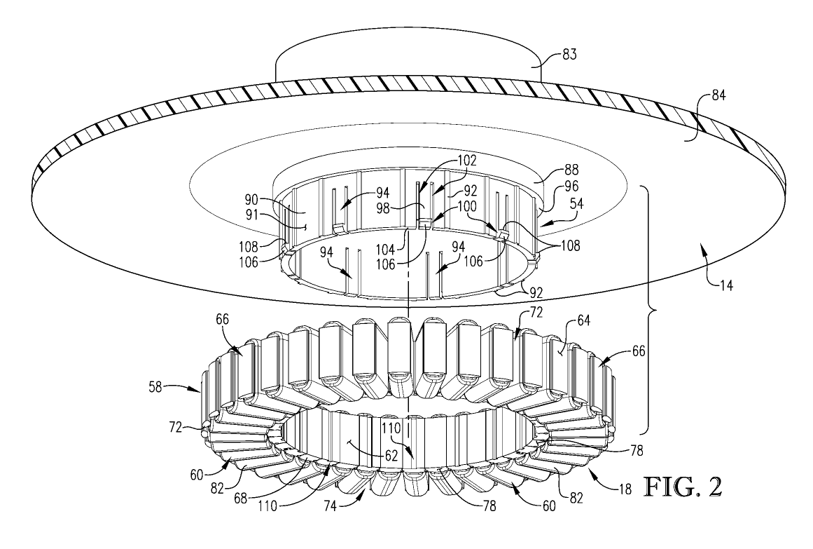

The tub 14 includes mounting structure 54 configured to fix the stator 18 to the tub 14, such that the stator 18 is fixed to and supported on the machine 12 by the mounting structure 54. In a preferred embodiment best shown in FIG. 2, the mounting structure 54 is integral with the tub 14, although non-integral attachment or interaction means are permissible.

In a preferred embodiment best shown in FIG. 1, the tub 14 is fixed to a tub mounting hub 56 that is rotationally isolated from the rotor 16 via the bearing assembly 48; and the stator 18 is mounted onto the tub 14 via the mounting structure 54. However, other means of fixing the tub 14 and the mounting structure 54 to the machine 12, whether the machine 12 is a washing machine or another type of machine, are within the scope of the present invention.

The mounting structure 54 is preferably composed of a synthetic resin material, although a different type or types of material, preferably being at least substantially electrically insulative, could be used without departing from the spirit of the present invention

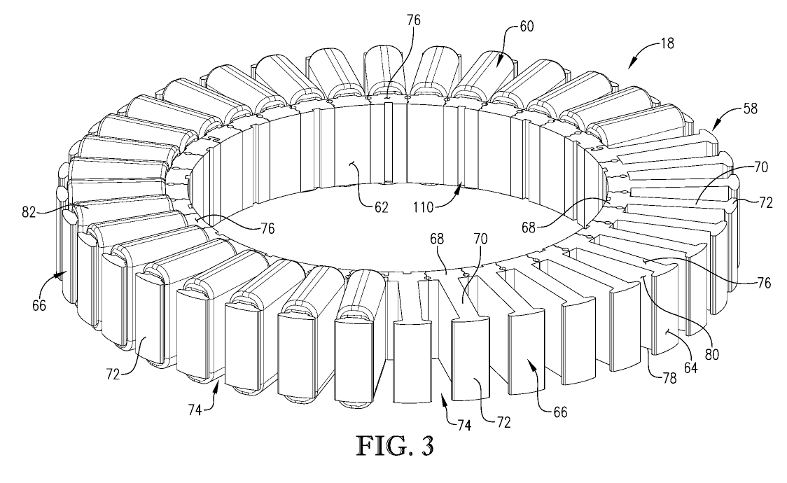

As best shown in FIGS. 2 and 3, the stator 18 includes a generally toroidal core 58 and a plurality of coils 60. In the preferred embodiment as shown, the core 58 presents radially inner and outer circumferential faces 62,64 and includes a plurality of radially projecting teeth 66, each of which comprises a yoke 68, an arm 70, and a crown 72. The yokes 68 are interconnected and collectively present the inner circumferential face 62, while the arms 70 and crowns 72 are arcuately spaced apart to define slots 74 therebetween. Each tooth 66 presents an upper face 76, a lower face 78, and two side faces 80. The crowns 72 of teeth 66 collectively present the outer circumferential face 64, which is thus discontinuous.

The stator core 58 preferably comprises a ferromagnetic material such as steel and is preferably a laminated structure. However, it is within the ambit of the invention for the core 58 to comprise an alternative material and be of an alternative structure. For instance, the core 58 could be integrally formed, be composed of iron, include a continuous annular base ring from which the teeth 66 project, or feature a combination of these or other variations known to one skilled in the art.

In a preferred embodiment, the stator core 58 is at least partly coated with an electrically insulative coating, preferably a powder coating. More preferably, the entire stator core 58 except the inner and outer circumferential faces 62,64 is powder coated. One suitable powder coating material is available from 3M′ under the designation Scotchcast™ Electrical Resin 5555. However, it is within the scope of the present invention for the stator core 58 to be insulated with other electrically insulative coatings (or low profile means that permit larger coils), as well as insulation arrangements that cover the core 58 to a lesser or greater degree than that shown.

The coils 60 of the stator 18 comprise electrically conductive wiring 82 wound multiple times around each individual tooth 66. The wiring 82 preferably substantially comprises a plurality of aluminum wires, although it is within the scope of the present invention to use other types of electrically conductive wires (such as copper). The wires may or may not be provided with coatings. (Note that the coils 60 are shown only schematically and have been removed from all or a plurality of the teeth 66 in some figures for the sake of clarity. However, in practice, the coils 60 would be found on each tooth 66 and would comprise multiple windings of the wiring 82.) As is customary, the wiring 82 is wound around the teeth 66 in a particular pattern according to phasing of the motor 10.

As best shown in FIG. 1, the tub 14 preferably comprises a substantially cylindrical inner portion 83, an annular base portion 84 that encircles the inner portion 83, and a cylindrical outer portion 85 positioned outwardly from the base portion 84. Preferably, the inner portion 83 projects both axially upwardly and axially downwardly from the base portion 84. However, it is within the scope of the present invention for the inner portion 83 to project in only one axial direction from the base portion 84.

Preferably, the inner portion 83 at least partly defines the mounting structure 54. However, it is within the scope of the present invention for the mounting structure 54 to be fully distinct from the inner portion 83.

In one embodiment, one or more transitional portions may be present between the main tub portions 83,84,85. As shown in FIG. 1, for instance, a transitional portion 86 is provided that integrally connects the base portion 84 and the outer portion 85, respectively. However, the use of any number of transitional portions, including no transitional portions, is allowable.

Preferably, the tub portions are related such that the tub is a unitarily formed body that has an axis of rotational symmetry that is coaxial with the axis of rotation of the rotor 16.

The mounting structure 54 preferably comprises an annular projection 88, a tubular wall 90 that presents an outer mounting surface 91, a plurality of longitudinally extending connecting pins 92, and a plurality of latches 94. The annular projection 88 projects axially downwardly from the base portion 84 of the tub 14. The tubular wall 90 projects axially downwardly from the annular projection 88. The connecting pins 92 project radially outwardly from the tubular wall 90 and, in a preferred embodiment, extend at least substantially along the axial length thereof. Preferably, the connecting pins 92 are circumferentially spaced around the tubular wall 90. More preferably, the connecting pins 92 are evenly spaced around the circumference of the tubular wall 90. However, alternative spacing arrangements are within the scope of the present invention.

A shoulder 96 is formed by the annular projection 88 adjacent the mounting surface 91, such that the shoulder 96 projects radially outwardly from the tubular wall 90. In a preferred embodiment, the shoulder 96 extends continuously about the circumference of the tubular wall 90. However, discontinuous extension is permissible as long as the shoulder remains at least partly distinct from the collective connecting pins 92.

The latches 94 are preferably integral with the tubular wall 90 and cooperate to define respective parts of the mounting surface 91. Each of the latches 94 includes an arm 98 and a catch 100. Each arm 98 is defined between a pair of spaced apart longitudinal slits 102 in the tubular wall 90. In a preferred embodiment, the tubular wall 90 comprises a lower margin 104 from which the slits 102 extend axially upwardly. Preferably, each catch 100 comprises an angled cam surface 106 and a flat supporting surface 108.

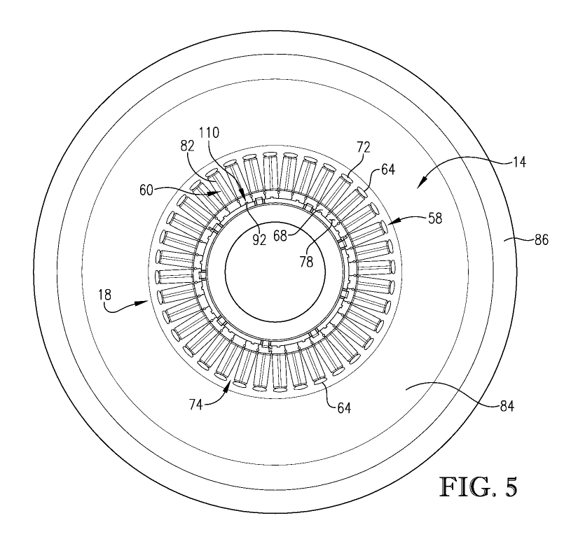

As best shown in FIGS. 2, 4, and 5, the mounting structure 54 and the stator 18 are preferably fixed relative to each other via a combination of means. For instance, in a preferred embodiment, a plurality of grooves 110 are formed in the inner circumferential face 62 of the core 58. Preferably, the grooves 110 correspond to the connecting pins 92. In this preferred embodiment, when the stator core 58 is mounted to the mounting structure 54, the connecting pins 92 are slid into respective grooves 110. The interaction of the connecting pins 92 with the grooves 110 prevents relative rotation between the stator core 58 and the mounting structure 54 and, in turn, between the stator core 58 and the tub 14.

If desired, grooves may also or alternatively be formed in the tubular wall of the mounting structure and configured to interact with connecting pins projecting from the inner circumferential face of the stator core.

If desired, the connecting pins 92 may be heat stake pins that, upon application of appropriate heat, create a permanent bond between the mounting structure 54 and the stator core 58. The provision of other means of adhesion between the connecting pins 92 and the grooves 110 is also acceptable. However, it is most preferred that the stator be removable for maintenance, replacement, etc.

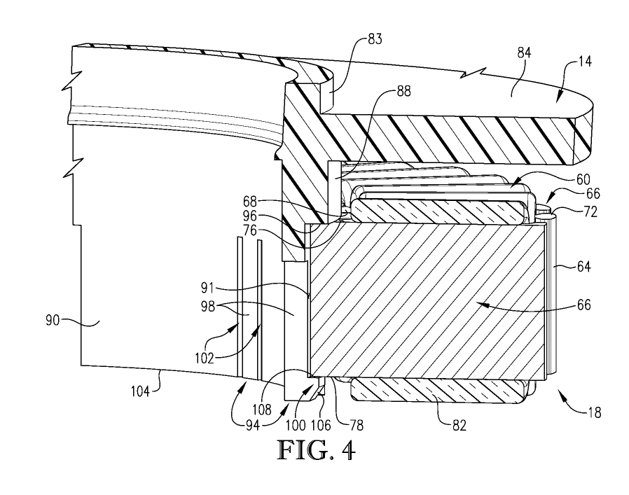

As best shown in FIGS. 1 and 4, in a preferred embodiment, the upper faces 76 of the teeth 66 are positioned flush with the shoulder 96 of the annular projection 88 when the stator core 58 is fully mounted on the mounting structure 54. Axial displacement of the stator core 58 relative to the mounting structure 54 and, in turn, the tub 14 in an upward direction is thereby restricted.

In a preferred embodiment best shown in FIGS. 1, 4, and 5, the flat supporting surface 108 of the catch 100 of each latch 94 engages the lower faces 78 of the teeth 66 when the stator core 58 is fully mounted on the mounting structure 54. The catches 100 thereby collectively restrict axial displacement of the stator core 58 relative to the mounting structure 54 and, in turn, the tub 14 in a downward direction.

For assembly of the preferred embodiment of the motor 10, the connecting pins 92 of the mounting structure 54 are first aligned with the grooves 110 in the inner circumferential face 62 of the stator core 58. No clocking is necessary beyond that required to align one of the pins 92 with one of the grooves 110, with the remaining pins 92 and grooves 110 automatically falling into alignment. The mounting structure 54 and the stator core 58 are then moved axially toward each other until the upper faces 76 of the teeth 66 are in contact with the angled cam surfaces 106 of the catches 100. The angle of each cam surface 106 is such that continued axial movement of the stator core 58 relative to the mounting structure 54 results in elastic flexing of each latch 94 in a radially inward direction. Preferably, each latch 94 is operable to flex in the radially inward direction to such a degree that continued axial movement of the stator core 58 relative to the mounting structure 54 is permitted without obstruction by the latches 94. Such flexing is enabled by the presence of the arms 98 and associated slits 102, in addition to the choice of material.

Although elastic flexing of the latches 94 based primarily on the properties of the material of construction is preferred, alternative modes of shifting are acceptable. For instance, spring-loaded latches could be used. The spring could be in a relaxed configuration when the latches are in the stator retaining position (shown in FIGS. 1 and 4), then compressed over the course of latch shifting (e.g., as the stator is mounted in place). In this embodiment, additional resistance to radially inward shifting of the latches would be provided. Assistance in a return to the original retaining position would be provided, as well.

As noted previously, the elastic flexing is preferably such that the latches 94 are positioned unobstructively for at least some degree of continued axial movement of the stator core 58 relative to the mounting structure 54. Such continued movement is preferably associated with the sliding engagement of the connecting pins 92 with the grooves 110. The continued relative axial movement preferably ceases when the shoulder 96 is positioned flush with the upper faces 76. Preferably, the engagement of the shoulder 96 with the upper faces 76 corresponds to the clearance of the catch 100 of each latch 94 relative to the lower faces 78 of the teeth 66. Such clearance preferably enables the previously flexed latches 94 to return to their unflexed configuration. The flat surface 108 of each catch 100 then engages the lower faces 78. Therefore, the shoulder 96 and the catches 100 cooperatively restrict further relative axial movement of the stator core 58 relative to the mounting structure 54 and, in turn, the tub 14 in either an upward or downward direction, respectively, while the connecting pins 92 and the corresponding grooves 110 cooperatively restrict relative rotation between the stator core 58 and the mounting structure 54 and, in turn, the tub 14.

Further means of restricting relative motion between the stator core 58 and the mounting structure 54 may be provided as well. In the illustrated embodiment, for instance, both the inner circumferential face 62 of the stator core 58 and the outer surface 91 of the tubular wall 90 are cylindrical, with the tubular wall 90 configured to fit snugly inside the stator core 58 when the machine 10 is assembled. Relative axial and rotational motion between the stator core 58 and the mounting structure 54 is therefore restricted by friction between the outer surface 91 and the inner circumferential face 62. Alternatively, the outer surface and the inner circumferential face could have dissimilar shapes. For instance, the outer surface could be polygonal and the inner face could be circumferential (as shown), so as to provide multiple discrete contact points between the components.

The stator core 58 can be removed from the mounting structure 54 after assembly. First, the latches 94 are disengaged (that is, flexed radially inwardly) to allow axial movement of the stator core 58 in a downward direction relative to the mounting structure 54. Such downward movement is associated with sliding removal of the connecting pins 92 from the grooves 110. When the upper faces 76 clear the catches 100, the stator core 58 is no longer engaged with the mounting structure 54; and the latches 94 return to their original, unflexed positions.

In operation of the preferred machine embodiment shown in FIG. 1, an electrical signal travels from a power source (not shown) through the wiring 82. The coils 60 energize the stator core 58, and the stator poles corresponding to each tooth 66 interact with the permanent magnets 42 and the backing ring 24 of the rotor 16 to induce rotation of the rotor 16, including the backing ring 24, the magnets 42, the interconnecting element 26, the central coupler 28, and the shaft 20, as well as the rotatable agitator or washer basket (not shown) of the machine 12. The tub 14, tub mounting hub 56, mounting structure 54, and stator 18 remain stationary. It is worth noting that the mounting structure 54, which supports the stator 18 and is preferably integral with the tub 14, is subject to both the weight of the stator 18 and to significant torsional loads.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A machine comprising:
a motor including—
a rotor rotatable about an axis, and
a stator spaced from the rotor,
said stator presenting axially spaced radial surfaces,
said stator further presenting radially spaced inner and outer circumferential faces; and
motor mounting structure configured to support the motor within the machine, said motor mounting structure including—
a mounting surface engaging at least one of the faces of the stator so as to restrict relative radial movement between the stator and mounting structure,
a radially projecting shoulder engaging one of the radial surfaces so as to prevent axial movement of the stator in a first axial direction, and
a shiftable catch removably engaging the other one of the radial surfaces so as to prevent axial movement of the stator in a second axial direction opposite the first direction, when the catch is in a retaining position,
said catch being moveable out of the retaining position to permit axial movement of the stator relative to the mounting structure.

2. The machine of claim 1; and
a stationary tub,
said mounting structure being integral with the tub.

3. The machine of claim 1,
said mounting surface and said at least one of the faces being substantially cylindrical.

4. The machine of claim 1,
said shoulder extending continuously circumferentially.

5. The machine of claim 1,
said catch comprising a resilient latch elastically shiftable out of the retaining position to allow axial movement of the stator relative to the latch.

6. The machine of claim 5,
said latch having an angled contact surface configured for engagement with said one of the radial surfaces when the stator is moved in the first axial direction, wherein the engagement results in a force that causes elastic shifting of the latch out of the retaining position to thereby allow axial movement of the stator relative to the mounting structure.

7. The machine of claim 6,
said latch being maintained out of the retaining position when the stator is moved in the first axial direction during mounting to the machine, with the latch returning to the retaining position when the force is no longer applied to the angled contact surface,
said latch serving to restrict movement of the stator in the second axial direction after the stator is mounted on the machine.

8. The machine of claim 5,
said elastic shifting of the latch out of the retaining position being in a radially inward direction.

9. The machine of claim 1,
said stator including a core having a plurality of teeth that are at least in part spaced arcuately from one another.

10. The machine of claim 9,
said teeth cooperatively presenting the outer circumferential face, with the outer circumferential face being discontinuous.

11. The machine of claim 9,
said stator core having a generally toroidal shape.

12. The machine of claim 11,
said mounting surface being substantially cylindrical.

13. The machine of claim 11,
said mounting surface being located generally inside the stator core.

14. The machine of claim 9,
said stator core having an electrically insulative coating applied thereon.

15. The machine of claim 14,
said teeth being at least partly coated with the electrically insulative coating.

16. The machine of claim 15,
said circumferential faces being devoid of insulative coating.

17. The machine of claim 9,
one of said mounting structure and said stator core including a radially projecting rib and the other of said mounting structure and stator core including a groove that receives at least part of the rib so as to angularly orient the stator core and mounting structure relative to one another.

18. The machine of claim 9,
said mounting structure and stator core comprising dissimilar materials.

19. The machine of claim 18,
said mounting structure comprising an electrically insulative material,
said core comprising an electrically conductive material.

20. The machine of claim 1,
said stator being spaced at least in part radially inside the rotor.

21. The machine of claim 20,
said rotor including a central coupler connectable to the machine, a backing ring that is located radially outward from the coupler and circumscribes the stator in a spaced relationship, and an interconnecting component extending between the coupler and ring.

22. The machine of claim 21,
said rotor including a plurality of permanent magnets mounted adjacent the backing ring.

23. A machine configured to operably support a motor having a rotor rotatable about an axis and a stator spaced from the rotor, wherein the stator presents axially spaced radial surfaces and radially spaced inner and outer circumferential faces, said machine comprising:
motor mounting structure configured to support the motor within the machine, said motor mounting structure including—
a mounting surface configured to engage at least one of the faces of the stator, such that the mounting surface is operable to restrict relative radial movement between the stator and mounting structure,
a radially projecting shoulder configured to engage one of the radial surfaces, such that the shoulder is operable to prevent axial movement of the stator in a first axial direction, and
a shiftable catch configured to removably engage the other one of the radial surfaces, such that the catch is operable to prevent axial movement of the stator in a second axial direction opposite the first direction, when the catch is in a retaining position,
said catch being moveable out of the retaining position to permit axial movement of the stator relative to the mounting structure.

24. The machine of claim 23; and
a stationary tub,
said mounting structure being integral with the tub.

25. The machine of claim 23,
said mounting surface and said at least one of the faces being substantially cylindrical.

26. The machine of claim 23,
said shoulder extending continuously circumferentially.

27. The machine of claim 23,
said mounting structure comprising an electrically insulative material.

28. The machine of claim 23,
said catch comprising a resilient latch elastically shiftable out of the retaining position to allow axial movement of the stator relative to the latch.

29. The machine of claim 28,
said latch having an angled contact surface configured for engagement with said one of the radial surfaces when the stator is moved in the first axial direction, wherein the engagement results in a force that causes elastic shifting of the latch out of the retaining position to thereby allow axial movement of the stator relative to the mounting structure.

30. The machine of claim 29,
said latch configured to be maintained out of the retaining position when the stator is moved in the first axial direction during mounting to the machine, with the latch configured to return to the retaining position when the force is no longer applied to the angled contact surface,
said latch thereby operable to restrict movement of the stator in the second axial direction after the stator is mounted on the machine.

31. The machine of claim 28,
said elastic shifting of the latch out of the retaining position being in a radially inward direction.
